(19) United States
(12) Patent Application Publication
(10) Pub. No.: US 2026/0050582 A1
(43) Pub. Date: Feb. 19, 2026

(54) SYSTEMS AND METHODS FOR MACHINE LEARNING ASSISTED SYSLOG PARSER GENERATORS

(71) Applicant: SecureWorks Corp., Atlanta, GA (US)

(72) Inventors: William Michael King, Atlanta, GA (US); Joseph Wilson, Atlanta, GA (US)

(21) Appl. No.: 18/748,404

(22) Filed: Jun. 20, 2024

(51) Int. Cl. G06F 16/21; G06N 20/00

(52) U.S. Cl. CPC G06F 16/211; G06N 20/00

(57) ABSTRACT

Systems and methods for generating a parser from a log file including: receiving a log file, wherein the log file is a structured text file of a plurality of data elements; invoking a machine learning model to: process the log file to identify name-value-pairs from the data elements; classify the log file as being associated with a schema based in part on the name-value pairs; map a first name-value pair to a first input field of the schema based on characteristics of the first name-value pair; determine a confidence level associated with mapping the first name-value pair to the first input field; and when the confidence level for mapping the first name-value pair exceeds a threshold, provide the first name-value pair to the first input field; and generating a parser from the plurality of input fields of the schema.

### TECHNICAL FIELD

The present disclosure relates to a system for generating log file parsers from a received syslog. In particular, the present disclosure relates to systems and methods for generating log file parsers from syslogs using machine learning techniques to classify and map the syslogs to a schema.

### BACKGROUND

Many enterprises lack the resources to have an inhouse team dedicated to detecting cybersecurity threats from their telemetry and network data, so these enterprises often contract out this task to other enterprises. Enterprises specialized in this task generally have their own standards for what data is collected and stored in log files. This presents challenges to detecting cybersecurity threats from enterprises that collect data using unsupported or proprietary devices and standards. Because these log files often lack standardized format and terminology, data elements in a first log file may have a different meaning from the same or similar data elements in a second log file associated with a different standard or device. For example, data elements in the first log file may indicate a cybersecurity threat, whereas the same or similar data elements in a second log file may actually be benign or unrelated to cybersecurity threats, and vice versa. To overcome this challenge, enterprises specialized in detecting cybersecurity threats may convert log files into a standardized format which the enterprise may use to identify cybersecurity threats regardless of the received log file's initial format or terminology.

Compilers and parsers may translate log files into a standard format which the enterprise may analyze to detect cybersecurity threats. Parsers are software components that provide the function of building a data structure from the received log file which the compiler may use when compiling a received log file. Parsers however are generally limited to processing log files that follow a particular format and include particular elements, (e.g. log files following a particular schema). Parsers are unable to accurately process log files that deviate in format from that which the parser is designed to process. To process log files deviating in format, a separate parser compatible with the log file's format is needed. Because individual enterprises have their own standards for how their log files are formatted, there exists a need for a system to generate parsers designed to process log files of a received format.

### SUMMARY

The present disclosure includes systems and methods for generating parsers to assist a compiler in compiling log files. The system may include a non-transitory computer-readable medium storing computer-executable program instructions and a processor communicatively coupled to the non-transitory computer-readable medium for executing the computer-executable program instructions.

In one aspect, the program instructions may include receiving a log file. Log files may include structured text files of including a plurality of data elements. Log files may be formatted under various standards such as following syslog standards, or a Common Event Format (CEF) and the log file's data elements may include various strings, characters, and numerical values representing data associated with an event occurring at or detected by a device. For example, a network router may generate a log file associated with a new unknown device joining a network. Various data elements of the log file might include the IP address of the device, the device type, a timestamp, and other telemetry and network data collected by the router. The processor may invoke a machine learning model configured to perform various processes including processing the log file to identify name-value-pairs from the various of data elements, and based on the identified name-value pairs, the machine learning model may classify the log file as being associated with a schema. The machine learning model may also map name-value pairs to respective input fields of the schema based on characteristics of the first name-value pair. For example, the characteristics of the name-value pairs may include text indicating the title of the name-value pair, values associated with the name-value pair, and the placement of the name-value pair within the log file. The machine learning model may also map name-value pairs to determine a confidence level associated with mapping the first name-value pair to the first input field. When the confidence level for mapping the first name-value pair to the input field exceeds a predetermined threshold, the machine learning model may provide the first name-value pair to the first input field. The processor may then generate a parser from input fields of the schema. The parsers may include at least part of the name-value pairs mapped to a respective input field. When the confidence level does not exceed the predetermined threshold, the machine learning model may leave the first input field blank or map a second name-value pair to the first input field.

These examples are mentioned not to limit or define the limits of the present subject matter, but to provide an example to aid understanding thereof. Illustrative examples are discussed in the Detailed Description, and further description is provided there. Advantages offered by various examples may be further understood by examining this specification and/or by practicing one or more examples of the claimed subject matter.

### BRIEF DESCRIPTION OF THE FIGURES

FIG. 1 is a block diagram illustrating an example syslog parser generator system.

FIG. 2 is a flowchart illustrating a first example method of generating a parser.

FIG. 3 is a flowchart illustrating a second example method of generating a parser.

FIG. 4A and FIG. 4B are block diagrams illustrating an example use of a machine learning model to generate a parser from a log file.

FIG. 5 is a block diagram illustrating a nearest neighbor machine learning model to classify a log file.

FIG. 6 is a block diagram illustrating an example random forest model for mapping data elements of a log file to input fields of a schema.

FIG. 7 is a block diagram illustrating an example user edited parser.

FIG. 8 is a flowchart illustrating an example method of editing and storing a parser.

### DETAILED DESCRIPTION

Aspects of the present disclosure relate to a system using various machine learning techniques to generate parsers for received log files and messages. The system may include an application operating in cloud infrastructure or executed locally on a user device to generate parsers for received log files. The application may receive a log file from a device and generate a parser for the log file and log files of the same or similar format. Log files may be formatted under various standards such as following syslog standards, or a Common Event Format (CEF) and the log file's data elements may include various strings, characters, numerical values, and combinations of strings, characters, and numerical values such as name-value pairs, representing data associated with an event occurring at or detected by a device, such as a cybersecurity threat. For example, a network router may generate a log file associated with a new unknown device joining a network. Various data elements of the log file might include the IP address of the device, the device type, a timestamp, and other telemetry and network data collected by the router.

The application may include a repository for storing parsers and a machine learning module to classify log files and map data elements of the log file to a schema. Schemas may include templates of a preset structure and format with input fields which the machine learning module may populate with data elements of the log file.

Briefly described, the system receives a log file and invokes a machine learning model to identify data elements of the log file. The system classifies the log file as being associated with a schema based on the identified data elements. The system may then map data elements of the log file to input fields of the associated schema based on characteristics of the data elements and the log file. For example, the data elements may include name-value pairs. Characteristics of the name-value pairs may include a product associated with the log file, product version, name of the device associated with the log file, type of device, timestamps, username, vendor names, and severity identifiers indicating cybersecurity threat levels. In one such example, a name-value pair may include the name of a device and an associated value representing a device's IP address.

The machine learning model may determine a confidence level associated with mapping data elements to input fields of the schema and compare the confidence level to a predetermined threshold to determine whether to provide the data element to the input field, provide a different data element to the input field, or to leave an input field blank. The machine learning model maps input fields of the schema with data elements of the log file, and the application generates a parser using a preset parser algorithm associated with the schema including mapped data elements. In some examples, the machine learning model includes the preset parser algorithm and generates the parser.

Users may use the generated parser in a compiler allowing to compile log files into a computer readable format compatible with an application for identifying and evaluating cybersecurity threats from log files. The application generating parsers may be a separate application from the application for evaluating cybersecurity threats or may be part of the same application.

Users receive the generated parser and may make edits to the parser. For example, users may disagree with the mapping of data elements to input fields of the schema, and add, remove, or amend data elements in the input fields as the user determines appropriate. Users may save these edited parsers locally or in a cloud repository. In some examples, users may provide the edited parser back to the machine learning model as training data to improve the machine learning model's classifying of log files and mapping of data elements to an associated schema.

### Example Syslog Parser Generator System

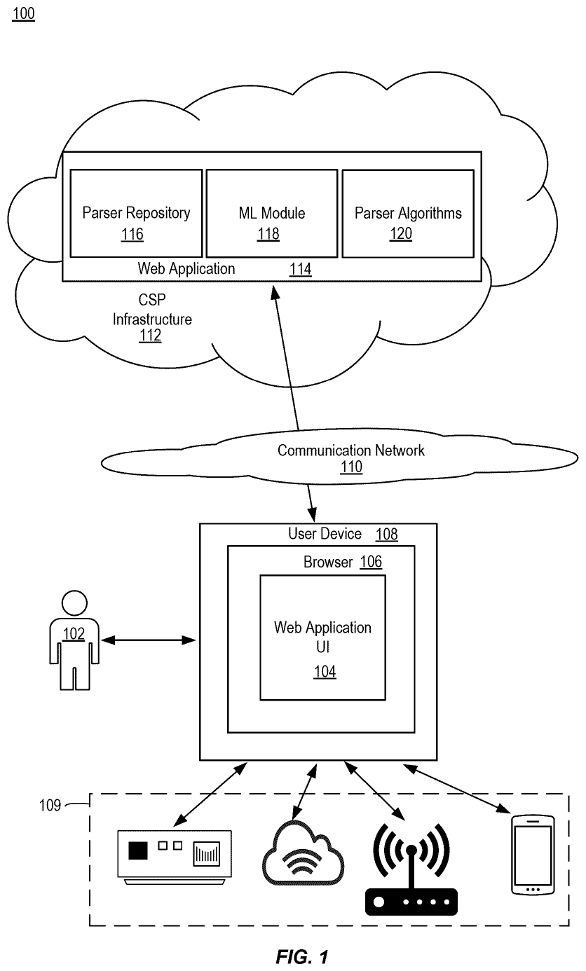

FIG. 1 illustrates an example syslog parser generator system 100. FIG. 1 depicts a user 102 interacting with a web application user interface (UI) 104 through a browser 106 operating on a user device 108, such as a laptop, tablet, phone, or other computing device. The user device 108 communicates with web application 114 through a communication network 110, such as the internet. As shown in FIG. 1, web application 114 may be executed on cloud service provider (CSP) infrastructure 112. The cloud service provider (CSP) infrastructure 112 may be comprised of various hardware and software components to facilitate the execution of web application 114, such as various servers, databases, and computing devices. In some examples, the web application 114 is an application executed locally on a user device. The cloud service provider (CSP) infrastructure and web application 114 may communicate with a plurality of additional user devices and receive various log files and messages from the plurality of additional user devices the web application may process.

The web application 114 includes a parser repository 116, a machine learning module 118, and a parser algorithm 120. Web application 114 receives one or more log files from user device 108. Users may provide a log file associated with a different device than the user device 108 providing the log file to the web application 114, such as network devices 109.

The machine learning module 118 may include multiple machine learning models for performing actions. For example, the machine learning module 118 may include a first machine learning model to classify log files as a particular schema and a second machine learning model to map data elements of log files to the schema. The machine learning module may use various machine learning models, algorithms, and techniques to classify log files and map data elements of log files to input fields of a schema, such as a nearest neighbor algorithm, naïve-bayes classifier and random forest models. In further examples, the machine learning module 118 may use a different machine learning model to classify log files from the machine learning model used to map data elements of log files to the schema. For example, the machine learning module 118 may use a nearest neighbor algorithm to classify log files and a random forest model to map data elements of log files to the schema.

In one such example, the machine learning module may employ various classifiers such as a support vector machine, which may classify testing data similar to previously classified training data. The machine learning module may use other directed and undirected model classification approaches such as naïve Bayes, Bayesian networks, decision trees, neural networks, fuzzy logic models, and probabilistic classification models to classify log files as being associated with a particular schema.

The machine learning module may employ explicitly trained classifiers, such as through curated training data, as well as implicitly trained classifiers that are implicitly trained (e.g., by receiving edited parsers from users, by receiving extrinsic information, and so on). Thus, the application may use the classifiers to determine, according to predetermined criteria, a classification associating a log file with a schema.

The web application 114 may use the machine learning module 118 to classify a log file as being associated with a schema, and map data elements of the log file to the schema. The parser algorithm 120 may use the schema including the mapped data elements to generate a parser. In some examples, web application 114 may include a plurality of parser algorithms and may select which parser algorithm to use based on the schema. Web application 114 may provide the parser generated from the parser algorithm to the user 102, which the user 102 may edit through the web application user interface (UI) 104.

User 102 may provide the edited parser to the web application to store in the parser repository 116, or a separate repository for edited parsers. In some examples, user 102 may store the edited parser locally on user device 108. In some examples, users may provide the edited parser or generated parser to web application 114, or a different web application to use in a compiler to compile log files into a standard format which the web application 114, or a different web application may use to identify and evaluate cybersecurity threats of events associated with the log files.

In further examples, the web application 114 may use edited parsers from the user as training data for the machine learning module 118 or to adjust the parser algorithms 120.

### Example Flow Diagrams for Generating a Parser

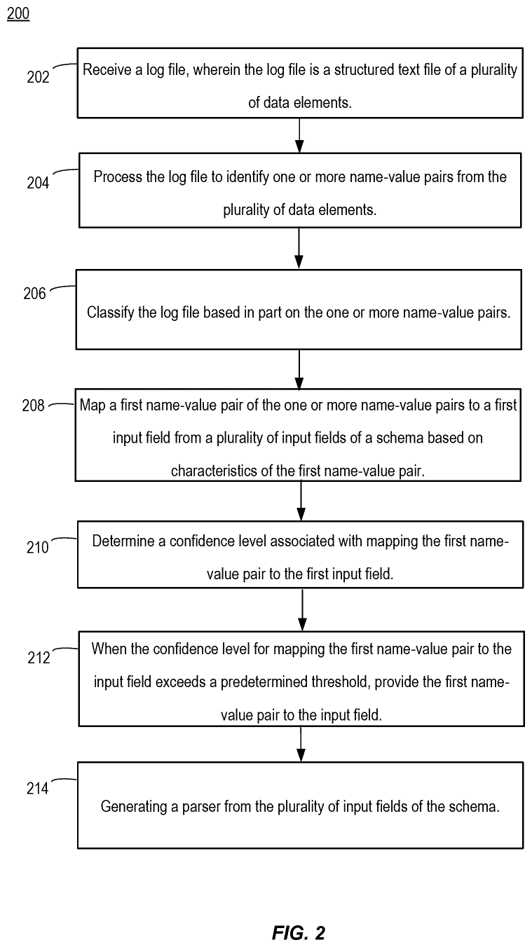

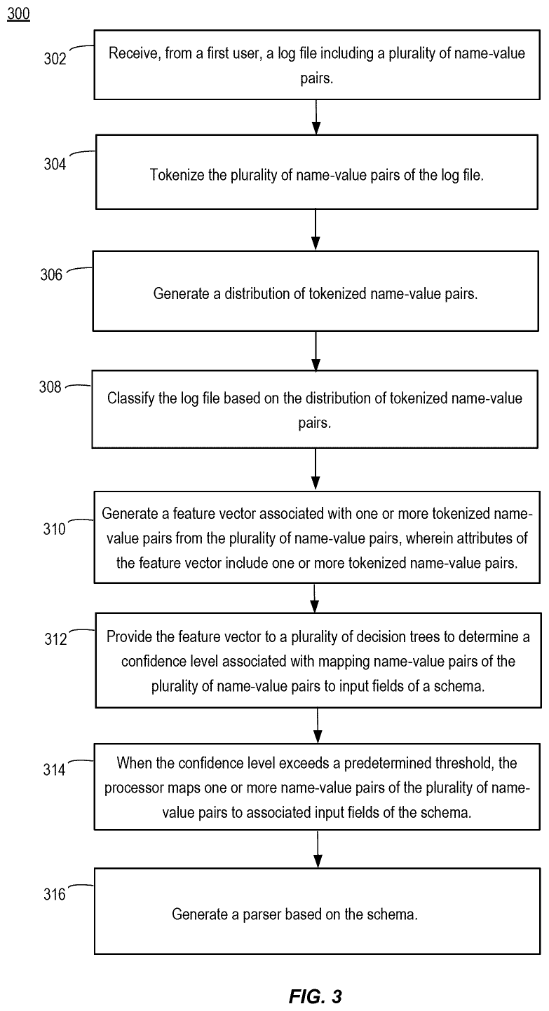

FIG. 2 and FIG. 3 illustrate example flow diagrams showing processes 200 and 300 for generating a parser. These processes, and any other processes described herein, are illustrated as a logical flow diagram, each operation of which represents a sequence of operations that may be implemented in hardware, computer instructions, or a combination thereof such as implemented in the system described in FIG. 1. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

FIG. 2 illustrates a flow diagram representing a process 200 of generating a parser. Process 200 may begin at block 202 which includes receiving a log file. For example, the web application 114 from FIG. 1 may receive a log file from user device 108. The log file may be associated with an event occurring at or detected by the user device 108, or another device such as a network router, gateway, transceiver, or bridge. Users may provide the log file to an application, such as web application 114 further described in the description of FIG. 1.

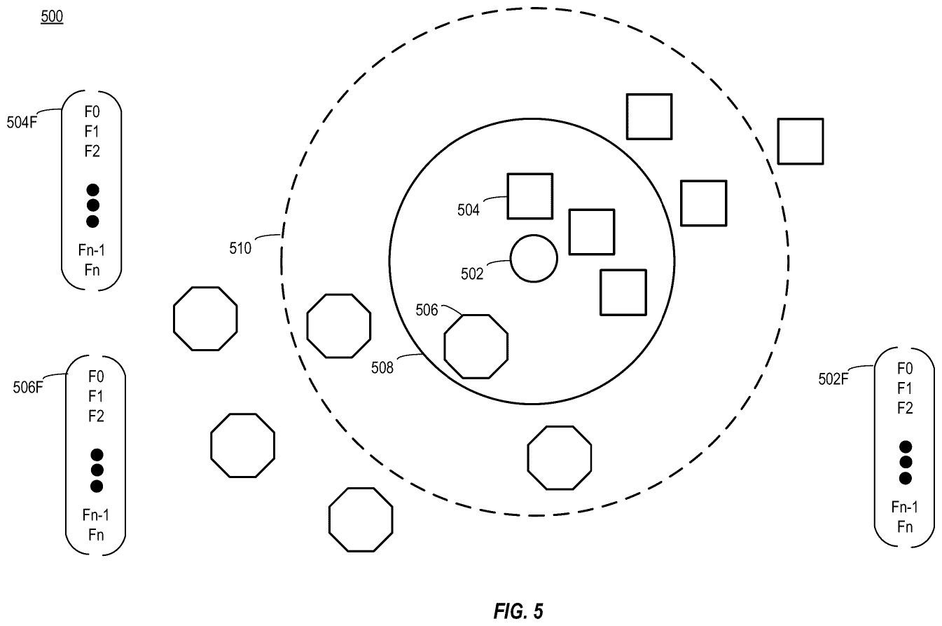

At block 204, process 200 includes processing the log file to identify one or more name-value pairs from the plurality of data elements. The web application 114 may invoke the machine learning module 118 from FIG. 1 to identify name-value pairs from the plurality of data elements of the log file. In some examples, the machine learning module 118 may identify name-value pairs from data elements of the log file based on characteristics of the data elements (e.g., terms used in the log file, values in the log file, structure of the log file including the position of data elements within the log file and file format) using a nearest neighbor algorithm, further described in the description of FIG. 5.

At block 206, process 200 includes classifying the log file based in part on the one or more name-value pairs. Classifying the log file may include associating the log file with a particular schema based on the data elements of the log file, such as the name-value pairs. The machine learning module 118 from FIG. 1 may classify the log file as being associated with a particular schema based in part on the name-value pairs, such as terminology used in the name-value pairs. For example, a name-value pair may include terminology indicating a type of device used to collect the telemetry data and network data, which the machine learning model may associate with a particular schema.

In some examples, the log file may include a header or title, which may include information associated with the arrangement of name-value pairs and other data elements within the log file which the machine learning model may associate with a particular schema. For example, a log file may have a header associated with a Common Event Format (CEF) log file, and the machine learning model may associate the Common Event Format (CEF) log file with a schema for log files based on data elements of the header and in addition to the arrangement of name-value pairs and other data elements within the Common Event Format (CEF) log file. For example, the header may include data elements representing an event class, name, device vendor, and product associated with the log file. The machine learning model may classify the log file based on the data elements within the header, in addition to the arrangement of name-value pairs and other data elements within the log file.

In some examples, the web application or machine learning model may also include rules-based processing for log files based on the header. For example, the web application or machine learning model may include rules that automatically associate a log file with a schema based on one or more keywords within a header, name-value pair, or data elements within the log file. For example, with headers including a product name such as “Product 1”, the machine learning model or web application may automatically associate the log file with a schema for “Product 1”.

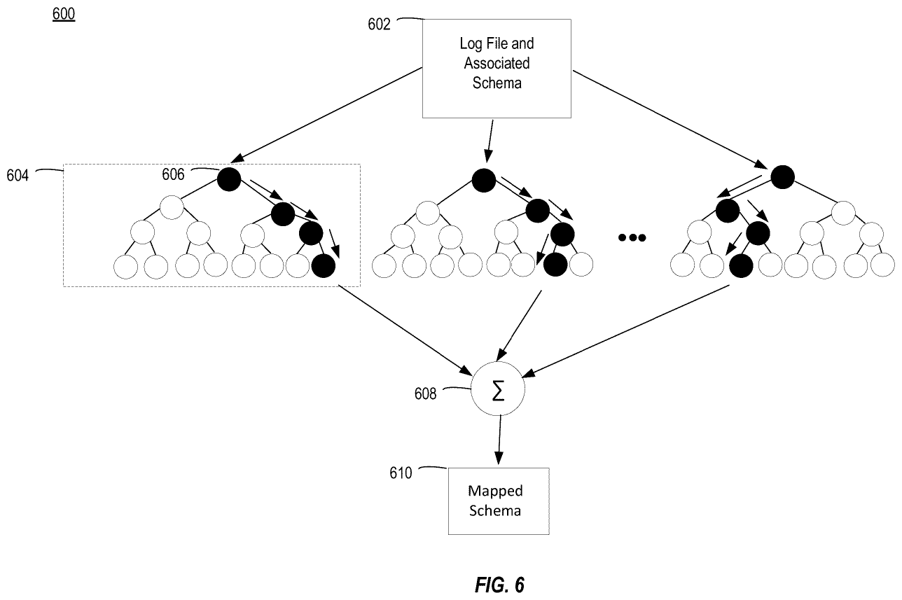

At block 208, process 200 includes mapping a first name-value pair of the one or more name-value pairs to a first input field from a plurality of input fields of a schema based on characteristics of the first name-value pair. The web application 114 from FIG. 1 may use the machine learning module 118 to map one or more name-value pairs to input fields of a schema, such as the schema associated with the log file from block 206. The machine learning module 118 may use a different machine learning algorithm to map the name-value pairs to the input fields of the schema, such as a random forest model, as further described in the description of FIG. 6.

Characteristics of the first name-value pair may include terminology used in the name-value pair, such as the names of devices or other data elements, the values associated with the terminology, and the location of the name-value pair within the log file and relative to other name-value pairs and other data elements within the log file.

At block 210, process 200 includes determining a confidence level associated with mapping the first name-value pair to the first input field. The machine learning module 118 may determine a confidence level associated with mapping the first name-value pair to the first input field based on characteristics of the first name-value pair, log file, and the first input field. For example, the first input field of the schema may be an input field for an IP address. The machine learning module 118 may identify that a value of the first name-value pair does not include an appropriate number of character values to be an IP address and determine that the name-value pair therefore has a low probability of being an IP address. The machine learning module 118 may assign a confidence level representing the probability of whether the name-value pair should be mapped to the input field.

In some examples, the confidence level may be normalized to a predetermined scale (e.g., 0 to 1, 0 to 100) to represent a probability that an individual name-value pair is associated with an input field of a schema and the machine learning module 118 should map the name-value pair to the input field. In other examples, the confidence level may be normalized to represent the probability that a name-value pair is associated with an input field in comparison to other name-value pairs from the plurality of data elements. In one such example with confidence levels normalized on a 0 to 1 scale, a log file with two name-value pairs may be processed by the machine learning module 118 to determine a confidence level associated with mapping the first name-value pair to a first input field, a confidence level associated with mapping a second name-value pair to the first input field, and a confidence level associated with not mapping either name-value pair to the first input field (e.g., confidence level 1=0.6, confidence level 2=0.3, and confidence level 3=0.1). This process may be performed for each input field of the schema.

At block 212, process 200 includes providing the first name-value pair to the input field when the confidence level for mapping the first name-value pair to the input field exceeds a predetermined threshold. For example, the predetermined threshold may be 0.6 which may represent a 60% probability that the first-name value pair is associated with the input field, and the machine learning module 118 should map the first name-value pair to the input field of the schema.

At block 214, process 200 includes generating a parser from the plurality of input fields of the schema. The generated parser may include part of the first name-value pair, such as terminology used in the first name-value pair. In some examples, the web application 114 generates the parser by inputting the schema including mapped name-value pairs to a parser algorithm.

FIG. 3 illustrates a flow diagram representing a process 300 for generating a parser. Process 300 may begin at block 302 which includes receiving from a first user, a log file including a plurality of name-value pairs. As further described in the description of FIG. 1, a web application may receive the log file from the first user.

At block 304, process 300 includes tokenizing the plurality of name-value pairs of the log file. For example, a machine learning module, such as the machine learning module 118 from FIG. 1, may process the log file by converting data elements of the log file into smaller pieces of data, such as strings, individual characters, or numerical values. In one such example, the log file may include data elements such as “Sep 6 01:23:45 67.891.0.12 SOME-DEVICE-JohnDoe02” which may be tokenized into separate strings (e.g., “Sep 6”, “01:23:45”, “67.891.0.12”, “SOME-DEVICE-”, and “JohnDoe02”).

At block 306, process 300 includes generating a distribution of tokenized name-value pairs. The machine learning module may generate the distribution based on the location of the name-value pairs in the log file and characteristics of the name-value pairs.

At block 308, process 300 includes classifying the log file based on the distribution of tokenized name-value pairs. The machine learning module may apply various machine learning models (nearest neighbor algorithms, support vector machines, trained and untrained classifiers, etc.) to classify the log file as being associated with a schema based on the distribution of the tokenized name-value pairs. For example, the machine learning model may include a nearest neighbor algorithm, further described in the description of FIG. 5.

At block 310, process 300 includes generating a feature vector associated with one or more tokenized name-value pairs from the plurality of name-value pairs, wherein attributes of the feature vector include one or more tokenized name-value pairs. The feature vector may further include information associated with the distribution of tokenized name-value pairs, such as information indicating which name-value pairs are located within the log file in relation to other name-value pairs (e.g., name-value pairs representing a title).

At block 312, process 300 includes providing the feature vector to a machine learning model using a plurality of decision trees to determine a confidence level associated with mapping name-value pairs of the plurality of name-value pairs to input fields of a schema. For example, the confidence level may represent a probability that the name-value pair is mapped to an input field of the schema. In some examples, the decision trees are part of a random forest model, such as the random forest model described in the description of FIG. 6.

At block 314, process 300 includes mapping, by the processor, one or more name-value pairs of the plurality of name-value pairs to associated input fields of the schema when the confidence level exceeds a predetermined threshold. In some examples, the confidence level does not exceed the predetermined threshold, the processor may leave the input field blank.

At block 316, process 300 includes generating a parser based on the schema. For example, the processor may use a parser algorithm associated with the schema to generate a parser for the log file. In some examples, the web application or processor may include a plurality of parser algorithms, and the web application or processor may select which parser algorithm to use based on the schema.

Example Machine Learning Model Generating a Parser from a Log File

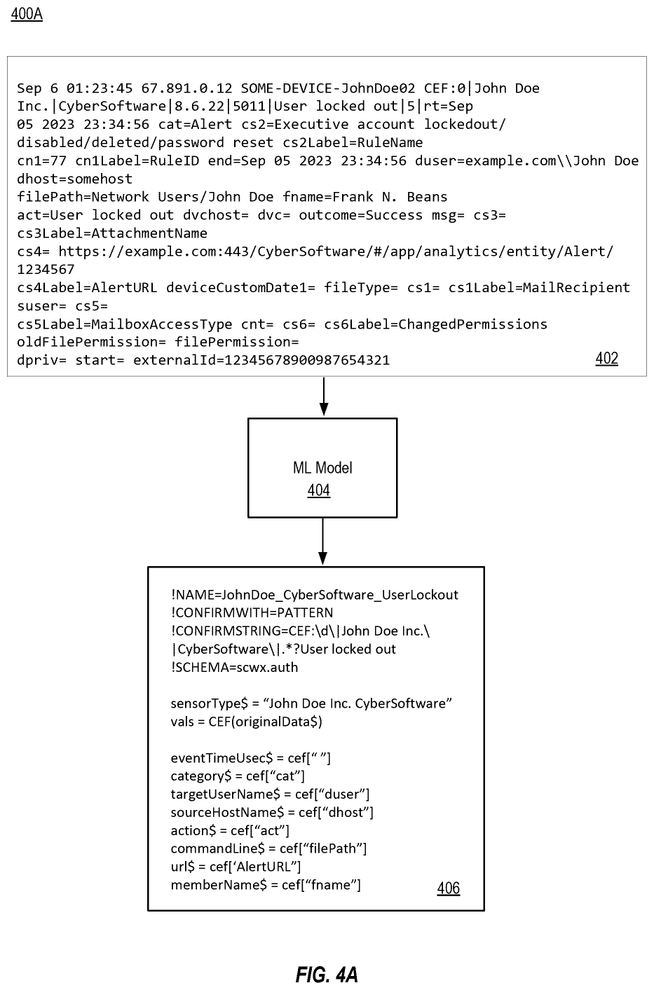

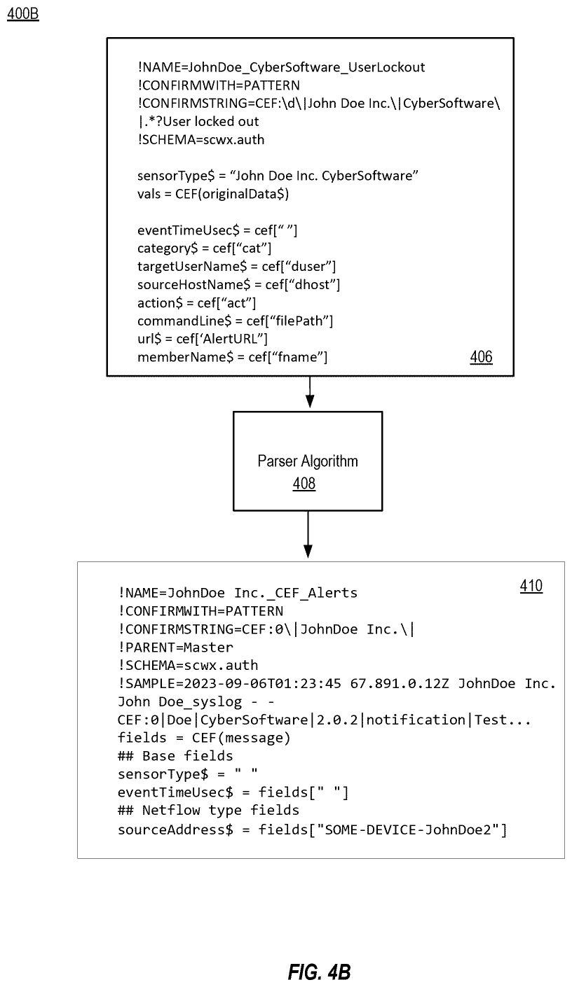

FIG. 4A and FIG. 4B illustrate a block diagram representing an example of using machine learning models to generate a parser from a log file. FIG. 4A includes a log file 402, a machine learning model 404, and a mapped schema 406. By way of a non-limiting example, below is an example log file 402 in Common Event Format (CEF).

Sep 6 01:23:45 67.891.0.12 SOME-DEVICE-JohnDoe02 CEF:0 |John Doe
Inc.| CyberSoftware | 8.6.22 |5011 | User locked out| 5 |rt=Sep
05 2023 23:34:56 cat=Alert cs2=Executive account lockedout/
disabled/deleted/password reset cs2Label=RuleName
cn1=77 cn1Label=RuleID end=Sep 05 2023 23:34:56 duser=example.com\\John Doe
dhost=somehost
filePath=Network Users/John Doe fname=Frank N. Beans
act=User locked out dvchost= dvc= outcome=Success msg= cs3=
cs3Label=AttachmentName
cs4= https://example.com:443/CyberSoftware/#/app/analytics/entity/Alert/1234567
cs4Label=AlertURL deviceCustomDate1= fileType= cs1= cs1Label=MailRecipient
suser= cs5=
cs5Label=MailboxAccessType cnt= cs6= cs6Label=ChangedPermissions
oldFilePermission= filePermission=
dpriv= start= externalId=12345678900987654321

The log file 402 includes a plurality of data elements, such as various name-value pairs representing events and information associated with an event associated with a device. For example, the log file 402 includes timestamps, device names, and an IP address.

A user may provide the log file 402 to a web application, as further described in the description of FIG. 1, which may input the log file to a machine learning module including machine learning model 404. The machine learning module may classify the log file as being associated with a schema, and map data elements of the log file to the schema. Further description of the classification of log files and mapping of data elements is provided in the description of FIG. 2 and FIG. 3.

By way of non-limiting example, an example mapped schema for log file 402 is provided below:

!NAME=JohnDoe_CyberSoftware_UserLockout
!CONFIRMWITH=PATTERN
!CONFIRMSTRING=CEF:\d\|John Doe Inc.\|CyberSoftware\|.*?User locked out
!SCHEMA=scwx.auth
sensorType$ = “John Doe Inc. CyberSoftware”
vals = CEF(originalData$)
eventTimeUsec$ = cef[“ ”]
category$ = cef[“cat”]
targetUserName$ = cef[“duser”]
sourceHostName$ = cef[“dhost”]
action$ = cef[“act”]
commandLine$ = cef[“filePath”]
url$ = cef[‘AlertURL”]
memberName$ = cef[“fname”]

FIG. 4B illustrates the mapped schema 406 applied to a parser algorithm 408 to generate parser 410. By way of non-limiting example, an example parser generated from mapped schema 406 is provided below:

!NAME=JohnDoe Inc._CEF_Alerts
!CONFIRMWITH=PATTERN
!CONFIRMSTRING=CEF:0\|JohnDoe Inc.\|
!PARENT=Master
!SCHEMA=scwx.auth
!SAMPLE=2023-09-06T01:23:45 67.891.0.12Z JohnDoe Inc. John Doe_syslog - -
CEF:0 | Doe | CyberSoftware | 2.0.2 | notification |Test...
fields = CEF(message)
## Base fields
sensorType$ = “ ”
eventTimeUsec$ = fields[“ ”]
## Authentication type fields
sourceAddress$ = fields[“SOME-DEVICE-JohnDoe2”]

In some examples, the parser includes various strings, characters, numerical values, and name-value pairs from the log file in input fields of the schema. By way of example, the parser above includes a name associated with the log file “JohnDoe Inc.”. The parser includes additional information including the type of schema “!SCHEMA=scwx.auth” to which the machine learning model mapped data elements of the log file.

In some examples, such as the example provided above, the parser algorithm may leave elements of the parser blank. For example, the machine learning model may leave one or more input fields of the mapped schema 406 blank when the machine learning model determines that none of the data elements of the log file meet a predetermined confidence level for mapping data elements to the input fields. The parser algorithm may generate a parser from the mapped schema including one or more blank input fields, which may cause one or more data elements of the parser to be blank or to include a NULL value. Users may review the parser for the blanks or NULL values and edit the parser to meet the user's needs. Users may store the edited parsers locally or upload the parser to a repository of edited parsers. In some examples, users may determine not to edit the generated parser, and may verify the parser works as expected by using the parser on an additional log file of the same or similar format as the log file used to generate the parser.

### Example Classification of Log Files

FIG. 5 illustrates a visual representation of a nearest neighbor machine learning model 500 used to classify a log file as being associated with a schema. The nearest neighbor machine learning model 500 includes log file point 502, schema 1 points 504, schema 2 points 506, and feature vectors of characteristics of the log file point 502 and schema points 504 and 506, such as log file feature vector 502F, schema 1 feature vector 504F, and schema 2 feature vector 506F. The schema 1 points 504 and the schema 2 points 506 may individually have separate feature vectors. For example, a first schema 1 point may have a different schema 1 feature vector 504F from a second schema 1 point. The schema points 504 and 506 may represent points within a coordinate system where the coordinates of the schema points 504 and 506 are defined by respective schema vectors 504F and 506F.

The schema vectors 504F and 506F may represent characteristics of training log files associated with a schema. For example, the schema 1 feature vector 504F may represent the characteristics of a training log file associated with schema 1.

The nearest neighbor machine learning model 500 may quantify characteristics of the feature vectors 502F, 504F, and 506F allowing the machine learning model 500 to measure distances between the log file feature vector 502F and the feature vectors associated with individual schema points from the schema 1 points 504 and schema 2 points 506.

The nearest neighbor machine learning model 500 may use the schema 1 feature vector 504F and the schema 2 feature vector 506F for the schema 1 points 504 and the schema 2 points 506 to determine which schema to associate with the log file. For example, the nearest neighbor machine learning model 500 may be a model including a dataset of training log files including various vocabulary terms represented in data elements within log files, types of data represented within log files, and other alpha tokens, alpha-numerics, and integer values represented in the data elements within the log files. For example, various vocabulary terms may include terms such as act, suser, duser, src, and dst. Various data types may include data elements representing IP addresses, port numbers, and URLs.

The feature vectors 502F, 504F, and 506F may include values within the vector indicating the presence, location relative to other values within the log file, and number of various vocabulary terms, data types, and other data elements within the log file and schemas. For example, a feature vector may be a numeric string represented as <1,1,1,1,1,2,0,0,0,0> and may represent the presence and number of various terms, data types, and other data elements within the log file and training log file associated with a schema as demonstrated below:

eventTimeUsec$: 1
targetUserName$: 1
sourceHostName$: 1
action$: 1
commandLine$: 1
url$: 2
sourceAddress$: 0
destinationAddress$: 0
sourcePort: 0
destinationPort: 0

The nearest neighbor machine learning model 500 may determine which schema of a set of schemas is more similar to the log file based on distance of log file feature vector 502F from the schema 1 feature vector 504F and distance from the schema 2 feature vector 506F. The nearest neighbor machine learning model 500 may classify the log file as being associated with the more similar of the schemas, as represented by the feature vectors of the schema 1 points 504 being a shorter distance away from the log file point 502.

In some examples when there are multiple schema 1 points 504 and schema 2 points 506, the nearest neighbor machine learning model 500 may average the distance between the log file point 502 and multiple schema 1 and schema 2 points to determine whether schema 1 or schema 2 are more similar to the log file. For example, the distance between two feature vectors may be calculated using normal Euclidean distance between the points, and the nearest neighbor machine learning model 500 may associate the log file with the closer of the feature vector associated with schema 1 and schema 2. In some examples including more than two schema points (i.e. an example including schema 3 points, schema 4 points, etc.), the machine learning model may classify a log file as being associated with a schema when two of the nearest three schema points, such as schema 1 points 504 and schema 2 points 506, are closer to the point represented by the log file feature vector 502F.

### Example Mapping of Elements

FIG. 6 illustrates a visual representation of a random forest model 600 used to map data elements, such as name-value pairs, of the log file to input fields of the schema associated with the log file. Various other machine learning models, algorithms, and techniques may be used map data elements to input fields of the schema. By way of non-limiting example, the random forest model 600 may be a machine learning model trained using supervised training techniques such as sequentially selecting features from a feature set of training log files that provide more or less amounts of information gain (e.g., changes in entropy resulting from the selection) from various configurations of the selections.

As another non-limiting example of training the random forest model 600, during training the presence of an IP address in a log file may be highly correlated with the authentication schema. The decision tree training step may include identifying that there are zero logs in the training set with a “authentication” classification schema that have no IP addresses in the log. The random forest model 600, operating as an ordered sequence of predicates, may include logic indicating “if the IPAddress dimension value is 0 then proceed to a branch of the tree where no schema predictions are the authentication schema.”

The random forest model 600 receives as input a log file and associated schema 602. In some examples, the random forest model 600 may receive a feature vector, such as the log file feature vector 502F and schema feature vectors 504F and 506F described further in FIG. 5 or individual features of the log file feature vector 502F and schema feature vectors 504F and 506F as inputs. These inputs are applied to one or more decision trees 604. The one or more decision trees may include various conditionals to test characteristics 606 of the log file and associated schema 602. For example, various characteristics 606 of the log file and associated schema 602 may include the positioning of data elements within the log file, values present in name-value pairs, and terminology used in the log file such as the names of the data elements.

Based on the results of the conditionals, the random forest model 600 generates a prediction 608 represented as a confidence level that a data element of the log file may map to an input field of the associated schema. When the confidence level is above a predetermined threshold, the random forest model 600 may map the data element to the associated schema to generate a mapped schema 610. In some examples, where multiple data elements are above the predetermined threshold, the random forest model 600 may map the data element with the higher confidence level to the input field. In further examples, the random forest model may return an error indicating that multiple data elements are above the predetermined threshold.

In another example, the machine learning model classifying the schema of log files, such as the machine learning model described further in the description of FIG. 5, may identify the presence captions by comparing captions to a preset list of captions in log files. For example, the captions may be the “name” element of a name-value pair, such as “src” in “src=10.20.30.40”. In further examples, the caption may be an excerpt including the name-value pair and further data elements of the log file.

By way of a non-limiting example, the machine learning model for classifying the schema of log files may include five preset caption values: src, user, cat, dst, act. The feature vector may have values associated with each of the five caption values, with each value being a 1 or 0 depending on whether the caption is present in the log file. For example, a log file may include “CEF: 0|Doe|CyberCompany|1.1|notification|src=10.20.30.40 dst=98.76.54.32 act=Allow”. The log file may have a feature vector of [1, 0, 0, 1, 1]. The machine learning model may receive the feature vector or log file as an input and output a predicted schema associated with the log file. Example schemas may include generic schemas and schemas associated with netflow, authentication, dns, and http.

The machine learning model associated with mapping data elements, such as the machine learning model described further in the description of FIG. 6, may receive the predicted schema as an input. The machine learning model associated with mapping data elements may also receive the log file, captions from the log file, and values from the name-value pairs of the log files as inputs. In some examples, the machine learning model associated with mapping data elements may correlate value types with input fields of the predicted schema. For example, the schema field “source_port” may be associated with a numeric value between 0 and 65535. The input field “source_address” may be associated with an IP address.

### Example Edited Parser

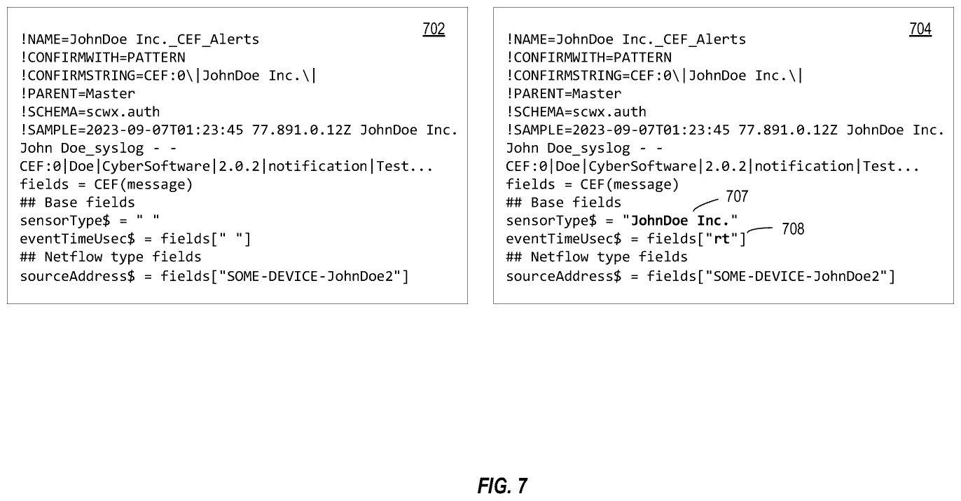

FIG. 7 illustrates an example parser 702 and an edited parser 704. By way of non-limiting example, an example parser generated by a web application, such as the web application 114 from FIG. 1, is provided below:

!NAME=JohnDoe Inc._CEF_Alerts
!CONFIRMWITH=PATTERN
!CONFIRMSTRING=CEF:0\|JohnDoe Inc.\|
!PARENT=Master
!SCHEMA=scwx.auth
!SAMPLE=2023-09-06T01:23:45 67.891.0.12Z JohnDoe Inc. John Doe_syslog - -
CEF:0|Doe|CyberSoftware|2.0.2|notification|Test...
fields = CEF(message)
## Base fields
sensorType$ = “ ”
eventTimeUsec$ = fields[“ ”]
## Authentication type fields
sourceAddress$ = fields[“SOME-DEVICE-JohnDoe2”]

By way of non-limiting example, an example edited parser 704 with bolded edits 707 and 708 is provided below:

!NAME=JohnDoe Inc._CEF_Alerts
!CONFIRMWITH=PATTERN
!CONFIRMSTRING=CEF:0\|JohnDoe Inc.\|
!PARENT=Master
!SCHEMA=scwx.auth
!SAMPLE=2023-09-06T01:23:45 67.891.0.12Z JohnDoe Inc. John Doe_syslog - -
CEF:0|Doe|CyberSoftware|2.0.2|notification|Test...
fields = CEF(message)
## Base fields
sensorType$ = “JohnDoe Inc.”
eventTimeUsec$ = fields[“rt”]
## Authentication type fields
sourceAddress$ = fields[“SOME-DEVICE-JohnDoe2”]

In some examples, users may edit the parser 702 through a text editor accessible through a user interface of the web application, such as web application user interface (UI) 104 from FIG. 1.

### Example Flow Diagrams for Editing Parsers

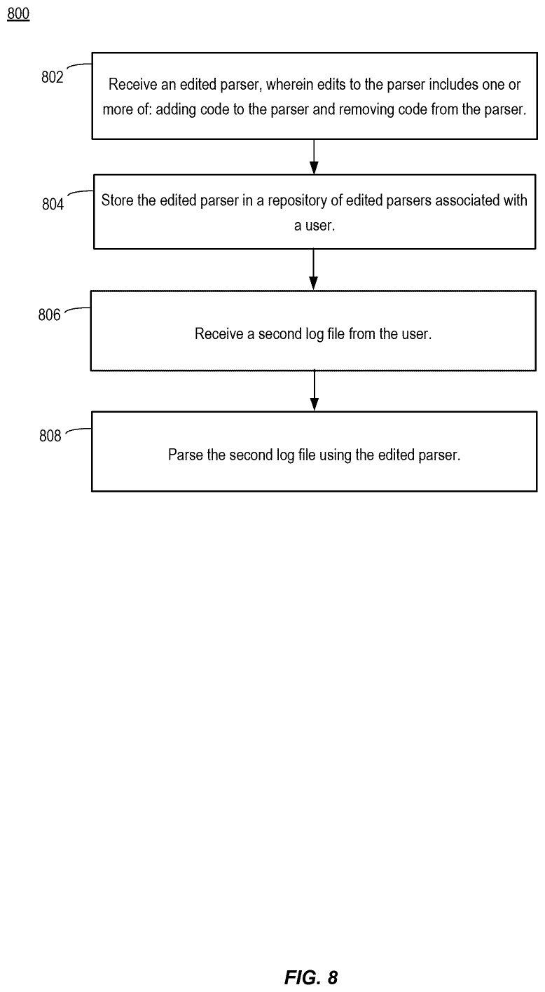

FIG. 8 illustrates an example flow diagram showing process 800 for editing a parser. This process, and any other processes described herein, are illustrated as a logical flow diagram, each operation of which represents a sequence of operations that may be implemented in hardware, computer instructions, or a combination thereof such as implemented in the system described in FIG. 1. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

At block 802, process 800 includes receiving an edited parser. For example, users may receive a generated parser by web application 114 from FIG. 1 and use the web application user interface (UI) to edit parsers. Edits to the parser may include one or more of: adding code to the parser and removing code from the parser. In some examples, the web application may include a code editor. In further examples, users may use a code editor or text editor independent of the web application 114 to edit parsers.

At block 804, process 800 includes storing the edited parser in a repository of edited parsers associated with a user. In some examples, the repository may be associated with a group of users, such as a group of employees at an enterprise.

At block 806, process 800 includes receiving a second log file from the user. The second log file may be associated with the same device or device type as the first log file. For example, the first log file may be associated with a first event occurring at a router, and the second log file may be associated with a second event occurring at the same router or a router of the same type (e.g., same model or version). At block 808, the user parses the second log file using the edited parser.

Different arrangements of the components depicted in the drawings or described above, as well as components and steps not shown or described are possible. Similarly, some features and sub-combinations are useful and may be employed without reference to other features and sub-combinations. Examples have been described for illustrative and not restrictive purposes, and alternative examples will become apparent to readers of this patent. Accordingly, the present examples are not limited to the examples of machine learning algorithms and techniques described above or depicted in the drawings, and various examples and modifications may be made without departing from the scope of the claims below. For avoidance of doubt, any combination of features not physically impossible or expressly identified as non-combinable herein may be within the scope of the described examples.

1. A computer-implemented method comprising:
receiving a log file from a user device, wherein the log file is a structured text file of a plurality of data elements;
invoking one or more machine learning models configured to:
process the log file to identify one or more name-value-pairs representing data associated with a cybersecurity threat event occurring at or detected by an affected device from the plurality of data elements;
classify the log file as being associated with a schema from a set of schemas based in part on the one or more name-value pairs;
map a first name-value pair of the one or more name-value pairs to a first input field from a plurality of input fields of the schema based on characteristics of the first name-value pair;
determine a confidence level associated with mapping the first name-value pair to the first input field; and
when the confidence level for mapping the first name-value pair to the first input field exceeds a threshold, provide the first name-value pair to the first input field;
generating a new parser from the plurality of input fields of the schema and the mapping using a parser algorithm associated with the schema, wherein the generated new parser includes at least part of the first name-value pair; and
using the new parser in a compiler to compile log files into a computer-readable format compatible with an application for identifying and evaluating cybersecurity threats from log files.

2. The computer-implemented method of claim 1, wherein the method further comprises:
receiving an edited parser, wherein edits to obtain the edited parser from an initial parser include one or more of: adding code to the initial parser, removing code from the initial parser, and adjusting values of the first name-value pair.

3. The computer-implemented method of claim 2, wherein the method further comprises:
storing the edited parser in a repository of edited parsers associated with a user;
receiving a second log file; and
parsing the second log file using the edited parser.

4. The computer-implemented method of claim 1, wherein the log file includes one or more name-value pairs associated with: a timestamp, a product, a product version, a vendor, a user, and a severity identifier indicating a cybersecurity threat.

5. The computer-implemented method of claim 1, wherein at least one name-value pair of the one or more name-value pairs includes terminology indicating a type of device used to collect telemetry data, network data, or a combination thereof associated with the cybersecurity threat event, wherein the type of device is used by the one or more machine learning models to classify the log file as being associated with the schema.

6. The computer-implemented method of claim 1, wherein the one or more machine learning models use one or more of: a naïve-bayes classifier and a random forest model to map the one or more name-value pairs to one or more input fields from the plurality of input fields of the schema.

7. The computer-implemented method of claim 2, wherein the one or more machine learning models are further configured to be trained using the edited parser as intrinsic training data to improve classifying of log files and mapping of data elements to an associated schema.

8. The computer-implemented method of claim 1, wherein when the confidence level for mapping the first name-value pair to the first input field does not exceed the threshold, determine a confidence level for mapping a second name-value pair from the one or more name-value pairs to the first input field.

9. The computer-implemented method of claim 8, wherein when no name-value pair of the one or more name-value pairs exceeds the threshold for mapping to the first input field, a portion of the new parser associated with the first input field of the schema is populated with a null value.

10. A system comprising:
a memory with instructions stored thereon; and
a processing device, coupled to the memory, the processing device configured to access the memory and execute the instructions, wherein the instructions cause the processing device to perform or control performance of operations comprising:
receiving a log file from a user device, wherein the log file is a structured text file of a plurality of data elements;
invoking one or more machine learning models configured to:
process the log file to identify one or more name-value-pairs representing data associated with a cybersecurity threat event occurring at or detected by an affected device from the plurality of data elements;
classify the log file as being associated with a schema from a set of schemas based in part on the one or more name-value pairs;
map a first name-value pair of the one or more name-value pairs to a first input field from a plurality of input fields of the schema from the set of schemas based on characteristics of the first name-value pair;
determine a confidence level associated with mapping the first name-value pair to the first input field; and
when the confidence level for mapping the first name-value pair to the first input field exceeds a threshold, provide the first name-value pair to the first input field;
generating a new parser from the plurality of input fields of the schema and the mapping using a parser algorithm associated with the schema, wherein the generated new parser includes at least part of the first name-value pair; and
using the new parser in a compiler to compile log files into a computer-readable format compatible with an application for identifying and evaluating cybersecurity threats from log files.

11. The system of claim 10, wherein the operations further comprise:
receiving an edited parser, wherein edits to obtain the edited parser from an initial parser include one or more of: adding code to the initial parser, removing code from the initial parser, and adjusting values of the first name-value pair.

12. The system of claim 11, wherein the operations further comprise:
storing the edited parser in a repository of edited parsers associated with a user;
receiving a second log file; and
parsing the second log file using the edited parser.

13. The system of claim 10, wherein the log file includes one or more name-value pairs associated with: a timestamp, a product, a product version, a vendor, a user, and a severity identifier indicating a cybersecurity threat.

14. The system of claim 10, wherein the one or more machine learning models use a nearest neighbor algorithm to classify the log file.

15. The system of claim 10, wherein the one or more machine learning models use one or more of: a naïve-bayes classifier and a random forest model to map the one or more name-value pairs to one or more input fields from the plurality of input fields of the schema.

16. The system of claim 11, wherein the one or more machine learning models are further configured to be trained using the edited parser as intrinsic training data to improve classifying of log files and mapping of data elements to an associated schema.

17. The system of claim 10, wherein operations further comprise:
when the confidence level for mapping the first name-value pair to the first input field does not exceed the threshold, determining a confidence level for mapping a second name-value pair from the one or more name-value pairs to the first input field.

18. The system of claim 17, wherein when no name-value pair of the one or more name-value pairs exceeds the threshold for mapping to the first input field, a portion of the new parser associated with the first input field of the schema is populated with a null value.

19. A system comprising:
a memory with instructions stored thereon; and
a processing device, coupled to the memory, the processing device configured to access the memory and execute the instructions, wherein the instructions cause the processing device to perform or control performance of operations comprising:
receiving, from a first user device, a log file including a plurality of name-value pairs representing data associated with a cybersecurity threat event occurring at or detected by an affected device;
tokenizing the plurality of name-value pairs of the log file;
generating a distribution of tokenized name-value pairs;
classifying the log file based on the distribution of tokenized name-value pairs;
generating a feature vector associated with one or more of the tokenized name-value pairs, wherein attributes of the feature vector include the one or more of the tokenized name-value pairs;
providing the feature vector to a plurality of decision trees to determine a confidence level associated with mapping name-value pairs of the plurality of name-value pairs to input fields of a schema, wherein when the confidence level exceeds a threshold, the operations further comprise mapping one or more name-value pairs of the plurality of name-value pairs to associated input fields of the schema;
generating a parser based on the schema using a parser algorithm associated with the schema; and
using the parser in a compiler to compile log files into a computer-readable format compatible with an application for identifying and evaluating cybersecurity threats from log files.

20. The system of claim 19, wherein the operations further comprise:
receiving an edited parser, wherein edits to obtain the edited parser from an initial parser include one or more of: adding code to the initial parser and removing code from the initial parser;
storing the edited parser in a repository of edited parsers associated with a user;
receiving a second log file from the user; and
parsing the second log file using the edited parser.
